(19) United States
(12) Patent Application Publication
(10) Pub. No.: US 2025/0371397 A1
(43) Pub. Date: Dec. 4, 2025

(54) METHOD FOR OPERATING A QUANTUM DEVICE

(71) Applicant: Oxford Ionics Limited, Begbroke (GB)

(72) Inventors: Maciej MALINOWSKI, Obergengstringen (CH); David Thomas Charles ALLCOCK, Eugene, OR (US)

(21) Appl. No.: 18/676,930

(22) Filed: May 29, 2024

(51) Int. Cl. G06N 10/40; G06N 10/20

(52) U.S. Cl. CPC G06N 10/40; G06N 10/20

(57) ABSTRACT

A method for operating a quantum device, wherein the quantum device configured to receive at least one laser beam from two or more laser light inputs and comprising an array of trapped ions comprising a plurality of trapped ions, the method comprising: applying the at least one laser beam to the array of trapped ions; and performing control operations using the quantum device by applying electric fields to the trapped ion array, wherein the electric field is generated by applying a voltage to a plurality of input ports of the quantum device.

### BACKGROUND

In a quantum device comprising a plurality of trapped ions, problems arise when attempting to control N trapped ions using lasers. It is known to do this by using more than one laser, each split into a plurality of laser beams, wherein each laser beam is separately modulated and aimed at a single ion or small group of ions. However, this method is very difficult to scale when N>>1 because of the challenges of optical engineering, particularly of the modulators.

As such, there is a need for a better solution for controlling, using lasers, a plurality of trapped ions.

### BRIEF SUMMARY

In a first aspect of the disclosure is provided a method for operating a quantum device, wherein the quantum device configured to receive at least one laser beam from two or more laser light inputs and comprising an array of trapped ions comprising a plurality of trapped ions, the method comprising: applying the at least one laser beam to the array of trapped ions; and performing control operations using the quantum device by applying electric fields to the trapped ion array, wherein the electric field is generated by applying a voltage to a plurality of input ports of the quantum device.

Optionally, wherein the performing control operations comprises applying each electric field to a group of at least one trapped ion of the trapped ion array.

Optionally, wherein applying the at least one laser beam comprises splitting each laser into a number of beams, wherein each beam is sent through at least one trapped ion of the array.

Optionally, wherein the number of beams is: equal to the number of trapped ions in the array; or less than the number of trapped ions in the array; or more than the number of trapped ions in the array.

Optionally, wherein the plurality of trapped ions comprises a plurality of groups of trapped ion qubits; wherein the array is configured such that the plurality of trapped ions are positioned to form spatially separated chain structures; wherein each chain structure comprises one group of the plurality of groups of trapped ion qubits.

Optionally, wherein applying the at least one laser beam comprises splitting each of the at least one laser beam into a number of beams sending the at least one laser beam through each trapped ion of a number of groups of the array sequentially.

Optionally, wherein the number of beams is equal to the number of groups of trapped ions in the array.

Optionally, wherein applying the at least one laser comprises splitting the at least one laser into a number of beams and sending the at least one laser through each trapped ion of a corresponding number of groups of the array sequentially.

Optionally, wherein applying the at least one laser further comprises sending the at least one laser beam through each trapped ion of a group of the plurality of groups of trapped ions.

Optionally, wherein applying the at least one laser beam comprises applying two laser beams at the same time.

Optionally, wherein the at least one laser beam has a width such that the at least one laser beam is applied to two or more trapped ions of the array simultaneously.

Optionally, wherein the at least one laser beam has a width such that the at least one laser beam is applied to each trapped ion of the array simultaneously.

Optionally, wherein the control operations include at least one of: dissipative operations and coherent operations.

Optionally, wherein the control operations are performed by applying the electric field to individual ions of the plurality of trapped ions to control translational and/or oscillation modes of the ions.

Optionally, wherein the control operations include at least one of: tuning a Rabi frequency; transition frequency tuning; phase tuning; and entangling gate Rabi frequency tuning.

Optionally, wherein the entangling gate Rabi frequency tuning is performed by one of: ion translation, mode frequency tuning, or mode orientation tuning.

Optionally, wherein the coherent operations include quantum operations; and wherein the quantum operations include at least one of single-qubit gate and multi-qubit gate.

Optionally, wherein the dissipative operations include at least one of: state preparation, readout, and laser cooling.

Optionally, wherein the trapped ions of the array of trapped ions encode quantum information.

In a second aspect of the disclosure is provided a quantum device comprising: an array of trapped ions comprising a plurality of trapped ions; wherein the quantum device is configured to: receive at least one laser beam from two or more laser light inputs; apply at least one of the two or more lasers to the array of trapped ions; and perform control operations using the quantum device by applying electric fields to the trapped ion array, wherein the electric field is generated by applying a voltage to a plurality of input ports of the quantum device.

Optionally, further comprising two or more laser light inputs.

### BRIEF DESCRIPTION OF THE DRAWINGS

The disclosure is described in further detail below by way of example only and with reference to the accompanying drawings in which:

FIG. 1 is a flowchart illustrating a method for operating a quantum device;

FIG. 2 is a diagram representing a method for operating a quantum device according to a first example;

FIG. 3 is a diagram representing a method for operating a quantum device according to a second example;

FIG. 4 is a diagram representing a method for operating a quantum device according to a third example;

FIG. 5 is a diagram representing a method for operating a quantum device according to a fourth example;

FIG. 6 is a diagram representing a method for operating a quantum device according to a fifth example;

FIG. 7 is a diagram representing a method for operating a quantum device according to a sixth example;

FIG. 8 is a diagram representing a method for operating a quantum device according to a seventh example;

FIG. 9 is a diagram representing a method for operating a quantum device according to an eighth example;

FIGS. 10a and 10b are diagrams of performing a control operation by controlling an translational movement of a trapped ion of the trapped ion;

FIGS. 11a and 11b are diagrams of performing a control operation by controlling an oscillation movement of a trapped ion of the trapped ion; and

FIGS. 12a and 12b are diagrams of performing a control operation by controlling a squeezing or widening potential of a trapped ion of the trapped ion.

### DETAILED DESCRIPTION

The following text will refer to a “quantum device” which refers to a device which utilizes quantum physics in order to perform computations or simulations, or to store data. For example, the quantum device may utilize quantum-mechanical systems including two-state systems (qubits), three-state systems (qutrits), four-state systems, and quantum mechanical continuous variable systems. In some examples, the quantum mechanical systems may be controlled using “all-electronic control” wherein the quantum mechanical systems are controlled using electric and/or magnetic fields. In other examples, the quantum mechanical systems may be controlled using laser fields. The quantum mechanical systems are controlled to perform quantum operations including coherent quantum operations (or “quantum gates”) and dissipative quantum operations such as qubit reset and qubit measurement.

In the following text, the quantum mechanical systems are encoded into electronic energy levels of ions, wherein the ions are stored in an ion trap. The ion trap comprises electrodes to which voltages may be applied to generate electromagnetic fields which may be used for the purpose of ion storage and manipulation. For example, the ion trap may be an RF trap (or “Paul trap”) or Penning trap or the like. For example, the ion trap may be a chip trap (or “surface-electrode trap”) or a stacked wafer trap (or “3D trap”).

Trapped-ion devices for quantum computing purposes (for example, the ion-trap chips of the disclosure), in general, comprise an ion trap in a vacuum chamber, a voltage source coupled to the ion trap and configured to apply a voltage to an electrode of the ion-trap chip to generate an electric field, a source of neutral atoms, a source of static magnetic field, a plurality of lasers and a fluorescence detector. The plurality of lasers serve a number of purposes, including the excitation and photo-ionisation of the neutral atoms into ions and laser cooling of ions.

Example quantum devices, and specifically trapped ion quantum devices, include trapped ion quantum computers, trapped ion quantum sensors, trapped ion atomic clocks, and the like.

In the following text, “control operations” refer to any operations which can be carried out inside the ion trap. For example, the control operations may include dissipative operations (such as state preparation, readout, and laser cooling) and coherent operations (such as quantum gates).

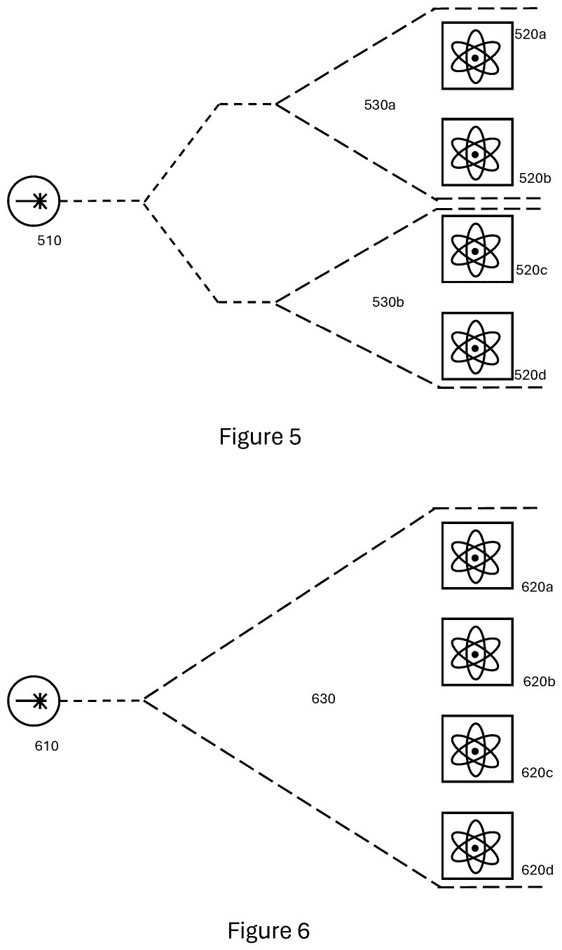

The control operations are operations carried out using the ion-trap devices by applying a voltage to an electrode of the ion-trap chips in order to generate an electromagnetic field, wherein the electric part of the electromagnetic field is used to control translational and/or oscillation modes of the ions. The voltage is applied in combination with the applications of a laser and/or a magnetic field pulse. These modes are described in detail with reference to FIGS. 5, 6, and 7.

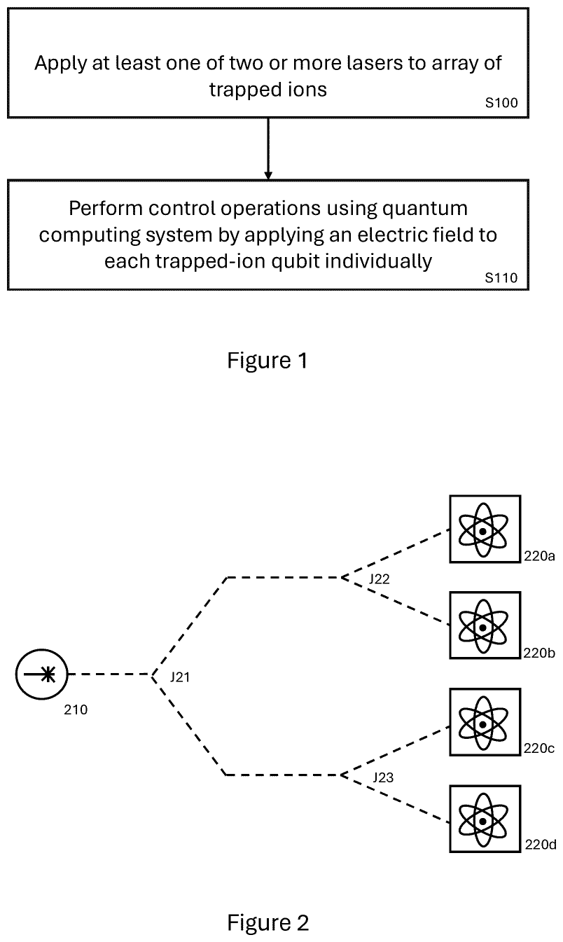

FIG. 1 is a flowchart illustrating a method for operating a quantum device according to a first embodiment, wherein the quantum device is configured to receive at least one laser beam from two or more laser light inputs and comprises an array comprising a plurality of trapped ions. The plurality of trapped ions may be trapped ions which encode quantum information, for example in the form of qubits. The laser light inputs may be any source of lasers and may be external to the quantum device, or may comprise part of the quantum device.

In step S100, at least one laser beam is applied to the array of trapped ions.

The at least one laser beam (or simply “laser”) of the two or more lasers may be applied to the array by any of a plurality of methods, including: by splitting a number of lasers into a number of beams (or paths) such that the number of lasers multiplied by the number of beams is equal to the number of trapped ions; by splitting each laser into a number of beams (or paths) equal to or less than (or alternatively, more than) the number of trapped ions; by sending (or directing) one of the two or more lasers through each trapped ion sequentially (if all the trapped ions are lined up) (so called “series modulation”); by widening the laser beam such that the laser beam is applied to the plurality of trapped ions of the array simultaneously; or through a combination of any of these methods.

In some examples, only one laser may be applied at a given time. In this case, each trapped ion may be hit by (wherein the laser beam is sent through the ion, such that the laser field of the laser beam is experienced by the ion) one laser or, in other words, may experience one laser field at a given time. Alternatively, not all the trapped ions may be hit by a laser at a given time. Examples of this can be seen in FIGS. 2, 3, and 4.

In examples in which two or more laser beams are applied, each trapped ion may be hit by more than one laser at the same time (or alternatively, by neither laser at a given time). That is, each trapped ion may experience a number of laser fields at the same time, wherein each laser field originates from a different laser. Alternatively, while two or more laser beams are applied, some trapped ions of the array may be hit by only one of the two lasers, or neither, and thus may experience only one laser field, or no laser field, at a given time. Examples of this can be seen in FIGS. 5, 6, and 7.

For example, the two or more lasers may be positioned on opposite sides of the array of trapped ions and may each be split into M beams wherein each beam hits L trapped ions in sequence (wherein the array comprises M*L number of trapped ions in the array), such that each trapped ion of the array is hit by the two or more lasers). In another example, each laser of the two or more lasers may be split into M/X number of beams, wherein each beam hits at least one trapped ion, such that the two or more lasers hit different areas of the array of trapped ions.

These methods are described in more detail in FIGS. 2 to 4.

In step S110, control operations are performed using the quantum device by applying a an electric field to each trapped ion individually, wherein the electric field is generated by applying a voltage to a plurality of input ports of the quantum device.

One or more control operations may be performed. The control operations are performed by applying the electric field to each trapped ion individually wherein the electric field can be used to perform translation and/or oscillation tuning operations. The translation and/or oscillation tuning operations are described in more detail in FIGS. 5 to 7.

In an example, the control operations are performed by applying the electric field while the laser is being applied. In another example, the control operations are performed before the laser is applied and, once the control operations have been performed, a laser pulse is applied wherein the laser is turned on and then turned off after a predefined period of time.

Thus, control (or tuning) of each individual trapped ion is provided by modulating the voltage provided to each qubit in order to change the applied electric field rather than modulating the laser applied to each trapped ion. Thus, control operations can be performed using the array of trapped ions such that the same control operations may be carried out on multiple trapped ions at once; or different control operations may be carried out on multiple trapped ions at once. Additionally, it allows some trapped ions to not be used (i.e. “ion hiding”), as well as implementing different operations in different areas of the array at the same time.

This approach significantly reduces the number of laser modulators required for parallel ion control by effectively replacing laser modulation with ion modulation.

The quantum device may comprise: an array of trapped ions comprising a plurality of trapped ions; and two or more lasers applied to the array of trapped ions; wherein the quantum device is configured to: apply at least one of the two or more lasers to the array of trapped ions; and perform control operations using the quantum device by applying an electric field to each trapped ion individually, wherein the electric field is generated by applying a voltage to a plurality of input ports of the quantum device.

FIG. 2 is a diagram of a method for operating a quantum device according to a first example. The first example illustrates a method of splitting a laser 210 (for example, the laser described by reference to FIG. 1) such that the laser 210 is split using parallel modulation.

The laser 210 is split into two beams at junction J21. For example, the laser may be split by a mirror, a plate beamsplitter, a cube beamsplitter, an integrated waveguide beamsplitter or any other appropriate means. Next, the two beams are split into four beams at junctions J22 and J23, respectively. The resulting four beams are then directed to ions 220a to 220d, wherein the ions 220a to 220d belong to the plurality of trapped-ion qubits of the array.

This example is not limited to producing four beams; it should be understood that the laser 210 can be split as many times as necessary to result in a beam per ion 220a to 220d. For example, applying the laser 210 to the array of trapped-ion qubits may comprise splitting the laser 210 into a number of beams (or paths), wherein the number of beams is equal to the number of trapped-ion qubits in the array.

That is, if there are N trapped-ion qubits (wherein each trapped ion comprises an ion), the laser 210 may be split N number of times to provide N beams, such that each beam is directed to one trapped-ion qubit of the plurality of trapped-ion qubits in the array.

In some examples, the array may be divided into groups such that there are multiple laser sources serving the array as a whole. For example, two or more laser sources may be applied to two or more groups of trapped-ion qubits of the array such that fewer splits of a single laser are required. In other examples, all of the trapped-ion qubits of the array may be served by a single laser source (as illustrated by FIG. 2).

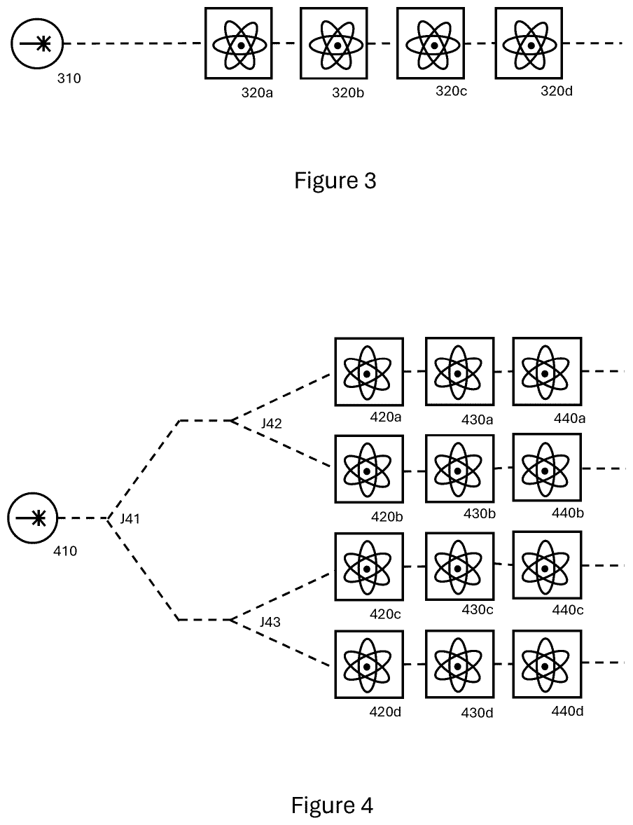

FIG. 3 is a diagram of a method for operating a quantum device according to a second example. The second example illustrates a method of sending a laser 310 (for example, the laser described by reference to FIG. 1) through each ion 320a to 320d by using series modulation.

In this example, the array may be configured such that each trapped-ion qubit of the plurality of trapped-ion qubits is aligned into a single line wherein each trapped-ion qubit is positioned next to another trapped-ion qubit in series. It should be understood that the trapped-ion qubits are not necessarily positioned in a straight line; it may be the case that the trapped-ion qubits are positioned along a curved path and therefore the laser may deflected (for example, by a mirror or other appropriate means) along the curved path.

The laser 310 may be directed (or aligned) such that the laser is sent (or passes or hits) through each trapped ion sequentially.

In some examples, the array may be divided into groups, wherein each group is associated with an individual laser source, such that each group is served by a laser using series modulation. In other examples, the whole array may be served by a single laser source (as illustrated by FIG. 3).

FIG. 4 is a diagram of a method for operating a quantum device according to a third example. The third example illustrates a method of directing a laser 410 (for example, the laser described by reference to FIG. 1) such that the laser 410 is sent through each trapped ion of the plurality of trapped ions of the array by using a combination of series and parallel modulation.

The laser 410 is split at junction J41 into two beams, before being split into a further four beams at junctions J42 and J43 (as per the first example described by reference to FIG. 2). The resulting four beams are then directed through groups of trapped ion (420a, 430a, 440a; 420b, 430b, 440b; 420c, 430c, 440c; and 420d, 430d, 440d) in series.

In this example, the array may be configured such that the plurality of trapped ion are positioned to form spatially separated chain structures, wherein each chain structure comprises one group of the plurality of groups.

The laser 410 may then be split into a number of beams (or paths) equal to a number of chain structures, and sending the laser 410 through each trapped ion of each group of the array sequentially.

That is, if there are a total of N trapped ion in the array, they may be split into M groups each comprising L trapped ion. The laser 410 may be split into M beams wherein each beam is directed to hit the L trapped ion of respective groups in sequence.

In some examples, the array may be divided into groups, wherein each group is associated with an individual laser source. For example, two or more laser sources may be applied to two or more groups of trapped ions of the array such that fewer splits of a single laser are required or such that fewer trapped ions are arranged in series. In other examples, all of the trapped ions of the array may be served by a single laser source (as illustrated by FIG. 2).

Alternatively, the laser 410 may be may be split into a number of beams, wherein the number of beams is not equal to a number of trapped ions or groups or trapped ions in the array. For example, the laser 410 may be split into a number of beams less than the number of trapped ions or groups of trapped ions in the array, or may be split into a number of beams greater than the number of trapped ions or groups of trapped ions in the array. Thus, it may be the case that a number of trapped ions or groups of trapped ions may not be affected by a laser beam at all, or may be affected by more than one laser beam at a given time.

Alternatively, or in addition to, any of the examples of FIGS. 2 to 4, the laser beam may be widened such that it is large enough to hit the entirety of, or selected areas of, the array of trapped ions simultaneously, as described now with reference to FIGS. 5 and 6.

FIG. 5 illustrates an example wherein a laser 510 is split into two beams, following which the two beams 530a and 530b are each widened such that they can hit a plurality of trapped ions simultaneously. For example, as shown, each beam 530a, 530b is widened to hit (or cover) two trapped ions each (420a and 420b; and 420c and 420d). For example, each beam 530a, 530b may hit two or more trapped ions after being widened. For example, when the array of trapped ions are positioned to form spatially separated chain structures (groups), each widened beam 530a, 530b, may hit two or more chain structures simultaneously.

FIG. 6 illustrates a specific example of the example described by reference to FIG. 5, wherein a laser 610 is widened such that the beam 630 it hits all of the trapped ions of the array (620a to 620d) simultaneously. For example, the laser beam 630 may hit two or more trapped ions after being widened. For example, when the array of trapped ions are positioned to form spatially separated chain structures (groups), the widened beam 630, may each chain structure simultaneously.

As such, although Figure shows four trapped ions, it should be understood that the array may comprise a large number of trapped ions (for example, hundreds or thousands of trapped ions).

That is, the beams of the two or more lasers may have a width such that the laser is applied to two or more trapped ions simultaneously. For example, the laser may be applied to each trapped ion of the array simultaneously.

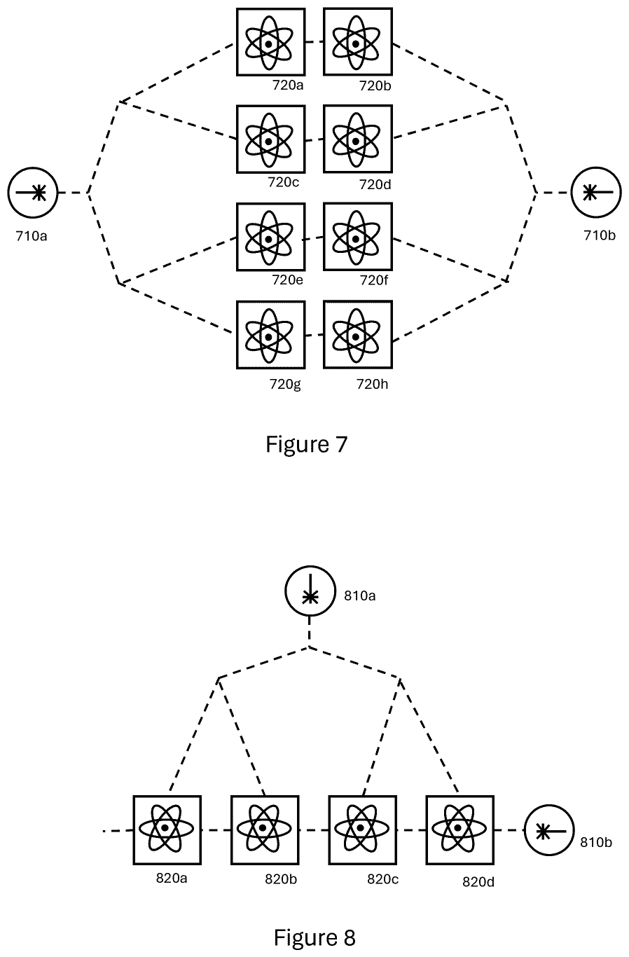

FIG. 7 is a diagram of a method for operating a quantum device according to a fourth example. The fourth example illustrates a method of directing two lasers 710a and 710b (for example, the two or more lasers described by reference to FIG. 1) such that the two lasers 710a and 710b are sent through each trapped ion of the plurality of trapped ions of the array by using parallel modulation.

Each laser 710a, 710b is split into two beams, before being split into a further four beams (as per the first example described by reference to FIG. 2). The resulting four beams are then directed through groups of trapped ions (720a, 720b; 720c, 720d; 720e, 720f; 720g, 720h) in series.

In this example, the array may be configured such that the plurality of trapped ions are positioned to form spatially separated chain structures, wherein each chain structure comprises one group of the plurality of groups.

Each laser 710a, 710b may then be split into a number of beams (or paths) equal to a number of chain structures, and sending each laser through each trapped ion of each group of the array sequentially.

That is, if there are a total of N trapped ions in the array, each laser 710a, 710b may be split into M groups each comprising L trapped ions. Each laser 710a, 710b may be split into M beams wherein each beam is directed to hit the L trapped ions of respective groups in sequence.

Thus, each trapped ion of the array is hit by each of the two laser 710a and 710b.

Alternatively, each laser 710a, 710b be may be split into a number of beams, wherein the total number of beams is not equal to a number of trapped ions or groups or trapped ions in the array. For example, each laser 710a, 710b may be split into a number of beams less than the number of trapped ions or groups of trapped ions in the array, or may be split into a number of beams greater than the number of trapped ions or groups of trapped ions in the array. Thus, it may be the case that a number of trapped ions or groups of trapped ions may not be affected by a laser beam at all, or may be affected by more than one laser beam at a given time.

FIG. 8 is a diagram of a method for operating a quantum device according to a fifth example. The fifth example illustrates a method of directing two lasers 810a and 810b (for example, the two or more lasers described by reference to FIG. 1) such that the two lasers 810a and 810b are sent through each trapped ion of the plurality of trapped ions of the array by using a combination of series and parallel modulation.

In this example, the array may be configured such that the plurality of trapped ions are positioned to form spatially separated chain structures, wherein each chain structure comprises one group of the plurality of groups.

The laser 810a is split into two beams, before being split into a further four beams (as per the first example described by reference to FIG. 2). The resulting four beams are then directed through groups of trapped ions (in this example, only the first ion of each group is shown 820a to 820d) in series.

Additionally, laser 810b is be directed (or aligned) such that the laser 810b is sent (or passes) through each spatially separated chain structure or group. In some examples, the two or more lasers may include one laser corresponding to each group.

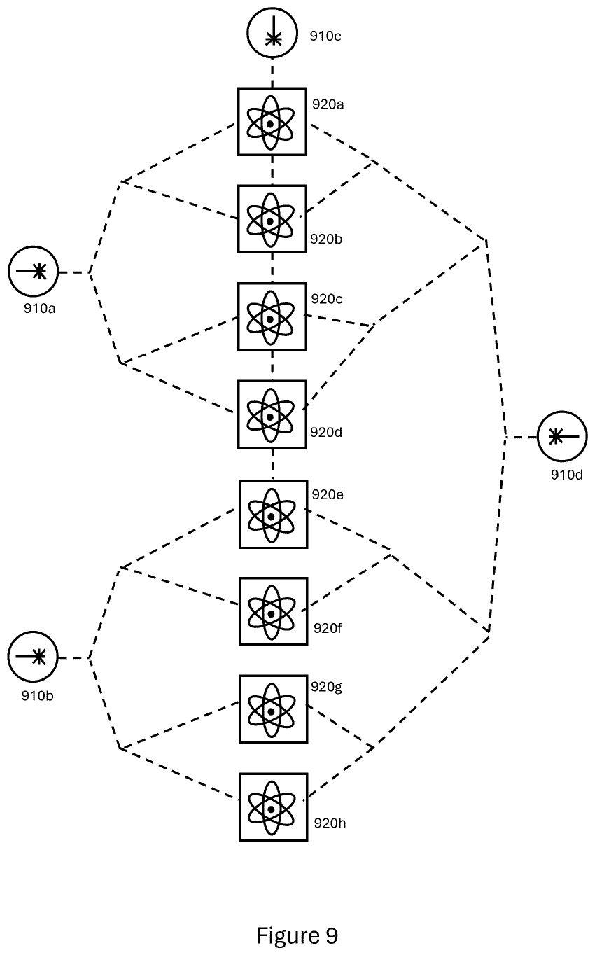

FIG. 9 is a diagram of a method for operating a quantum device according to a sixth example. The sixth example illustrates a method of directing a plurality of lasers 910a to 910d (for example, the two or more lasers described by reference to FIG. 1) such that the plurality of lasers 910a to 910d are sent through trapped ions of the array by using a combination of series and parallel modulation.

In this example, the array may be configured such that the plurality of trapped ions are positioned to form spatially separated chain structures, wherein each chain structure comprises one group of the plurality of groups.

The lasers 910a and 910b are each split into two beams, before being split into a further four beams (as per the first example described by reference to FIG. 2). The resulting four beams are then directed through at least one trapped ion (in some examples, the beams may be directed through groups of trapped-ion in series).

Similarly to the example described with reference to FIG. 8, laser 910c is be directed (or aligned) such that the laser 910c is sent (or passes) through each spatially separated chain structure or group. In some examples, the two or more lasers may include one laser corresponding to each group.

Additionally, laser 910d is split first into two beams, before being split into a further four beams, before being split into a further eight beams. The resulting eight beams are then directed through at least one trapped ion (in some examples, the beams may be directed through groups of trapped-ion in series).

Thus, it can be seen that a plurality of lasers may be used in a combination of parallel and series modulation to provide a laser field to each trapped ion of the array. Additionally, it can be seen that the plurality of lasers can be controlled such that each trapped ion can be hit by one or more laser beams at the same time.

Alternatively, each laser may be may be split into a number of beams, wherein the total number of beams is not equal to a number of trapped ions or groups or trapped ions in the array. For example, the plurality of lasers may be split into a number of beams less than the number of trapped ions or groups of trapped ions in the array, or may be split into a number of beams greater than the number of trapped ions or groups of trapped ions in the array. Thus, it may be the case that a number of trapped ions or groups of trapped ions may not be affected by a laser beam at all, or may be affected by more than one laser beam at a given time.

It should be understood that any of the examples illustrated in FIGS. 2 to 9 may be combined in various ways and that their combination does not depart from the scope of the application. For example, a parallel modulation application such as shown in FIG. 3 might be combined with a beam widening application such as shown in FIG. 6, and so on.

It should be understood that that more than two laser light sources (or lasers) may be used in any of the examples described with reference to FIGS. 2 to 9. For example, three or more lasers may be used.

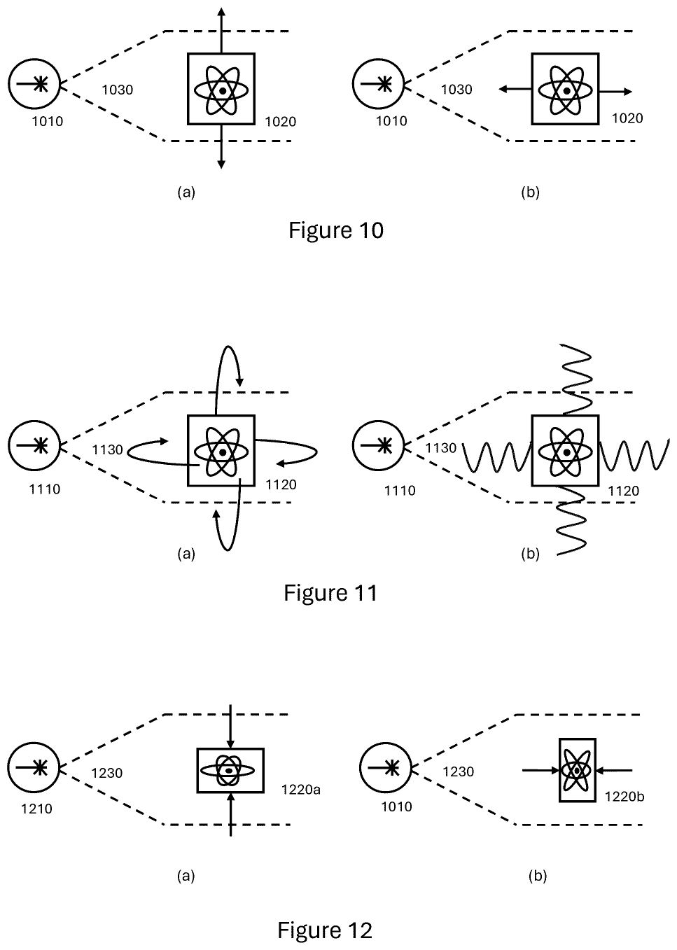

Furthermore, it should be understood that those examples are not meant to be geometrically accurate. For example, laser beams represented as counter-propagating may be co-propagating; and the plurality of lasers may have overlapping propagation directions. FIGS. 10 to 12 are diagrams which represent performing a control operation by controlling a translational or oscillation mode of a trapped ion of the trapped ions of the array. The trapped ion is a charged particle which, when within a laser beam, can be caused to move in various ways according to the application of an electric field generated by applying a voltage to electrodes coupled to the ion trap chip. As such, the trapped ions of the array can be individually tuned by moving them within the applied laser beam (or laser beams) by applying the electric field.

FIGS. 10a and 10b are diagrams which represent performing a control operation by controlling translational movement of a trapped ion of the trapped ions of the array.

A laser 1010 is applied to the ion 1020 according to any of the methods described with reference to FIGS. 2 to 9.

With reference to FIG. 10a, while the laser 1010 is being applied, an electric field is applied to the ion 1020 (for example, generated via a voltage source such as an electrode coupled to the trapped ion) which causes the ion 1020 to move in a translational mode, up or down (along a y axis) from a central position. The ion 1020 is moved up or down within the laser beam.

With reference to FIG. 10b, while laser 1010 is being applied, an electric field is applied to the ion 1020 which causes the ion 1020 to move in a translational mode, left or right (along an x axis) from a central position. The ion 1020 is moved right or left within the laser beam.

These translational modes can be used to modify at least one of an intensity, a phase, and an orientation of a laser field experienced by the ion of the trapped ion. By exploiting inhomogeneities in the ion trap, the translational modes can be used to modify the frequencies of internal and motional transitions of the trapped ions. At least one of these effects may be used to tune parameters of a Hamiltonian governing a time-evolution of the ion (for example, during coherent or dissipative operations). Thus, the translations modes may be used to perform operations such as operation Rabi frequency tuning, transition frequency tuning, operation phase tuning, and entangling gate Rabi frequency tuning.

By applying an electric field to each trapped-ion of the array of trapped ions individually, it is possible to individually tune each trapped-ion. As such, different operations can be performed on different trapped ions at the same time.

FIGS. 11a and 11b are diagrams of performing a control operation by controlling an oscillation movement of the trapped ion of the trapped ion.

A laser 1110 is applied to the ion 1120 according to any of the methods described with reference to FIGS. 2 to 9.

With reference to FIG. 11a, while laser 1110 is being applied, an electric field is applied to the ion 1120 (for example, generated via a voltage source such as an electrode coupled to the trapped ion) which causes the ion 1120 to spin (or turn) laterally or longitudinally about an axis (for example, an x, y, or z axis).

With reference to FIG. 11b, while laser 1110 is being applied, an electric field is applied to the ion 1120 which causes the ion 1120 to oscillate up and down along an axis (for example, an x or y axis).

Referring to both FIGS. 11a and 11b, the electric field can be applied to control two degrees of freedom of the ion within the laser beam.

FIGS. 12a and 12b are diagrams of performing a control operation by controlling a squeezing or widening potential of the trapped ion of the array.

A laser 1210 is applied to the ion 1220 according to any of the methods described with reference to FIGS. 2 to 9.

With reference to FIG. 12a, while laser 1210 is being applied an electric field is applied to the ion 1220 (for example, generated via a voltage source such as an electrode coupled to the trapped ion) which causes the ion 1220 to be squeezed or widened laterally or longitudinally along an axis (for example, an x or y axis).

Additionally, an orientation of a potential of the ion may be changed, For example, by squeezing the ion potential along a direction x, the oscillation frequency of the ion may be increased along the direction x. For example, by widening the ion potential along the direction x, the oscillation frequency of the ion may be decreased along the direction x. For example, the ion potential can be rotated by x degrees in order to rotate the direction of the ion oscillation by x degrees.

To compare the translational and oscillation modes, it should be understood that ion translation along the direction x refers to moving a minimum of the ion potential along the direction x, while ion oscillation along the direction x refers to increasing an amplitude of the ion oscillation along the direction x.

It should be understood that any of the methods of performing a control operation as illustrated in FIGS. 10 to 12 may be used in combination with any of the methods described by reference to FIGS. 2 to 9.

It should be understood that the diagrams in FIGS. 2 to 12 are merely illustrative and should not be understood as limiting. It should be understood that these drawings are not geometrically accurate. For example, where parallel lines are shown, it should be understood that this is not intended to limit to the parallel propagation of laser beams. Similarly, all angles are merely illustrative and should not be construed as limiting.

Various improvements and modifications may be made to the above without departing from the scope of the disclosure.

1. A method for operating a quantum device, wherein the quantum device configured to receive at least one laser beam from two or more laser light inputs and comprising an array of trapped ions comprising a plurality of trapped ions, the method comprising:
applying the at least one laser beam to the array of trapped ions; and
performing control operations using the quantum device by applying electric fields to the trapped ion array, wherein the electric field is generated by applying a voltage to a plurality of input ports of the quantum device.

2. The method of claim 1, wherein the performing control operations comprises applying each electric field to a group of at least one trapped ion of the trapped ion array.

3. The method of claim 1, wherein applying the at least one laser beam comprises splitting each laser into a number of beams, wherein each beam is sent through at least one trapped ion of the array.

4. The method of claim 3, wherein the number of beams is:
equal to the number of trapped ions in the array; or
less than the number of trapped ions in the array; or
more than the number of trapped ions in the array.

5. The method of claim 1, wherein the plurality of trapped ions comprises a plurality of groups of trapped ion qubits;
wherein the array is configured such that the plurality of trapped ions are positioned to form spatially separated chain structures;
wherein each chain structure comprises one group of the plurality of groups of trapped ion qubits.

6. The method of claim 5, wherein applying the at least one laser beam comprises splitting each of the at least one laser beam into a number of beams sending the at least one laser beam through each trapped ion of a number of groups of the array sequentially.

7. The method of claim 6, wherein the number of beams is equal to the number of groups of trapped ions in the array.

8. The method of claim 5, wherein applying the at least one laser comprises splitting the at least one laser into a number of beams and sending the at least one laser through each trapped ion of a corresponding number of groups of the array sequentially.

9. The method of claim 5, wherein applying the at least one laser further comprises sending the at least one laser beam through each trapped ion of a group of the plurality of groups of trapped ions.

10. The method of claim 1, wherein applying the at least one laser beam comprises applying two laser beams at the same time.

11. The method of claim 5, wherein the at least one laser beam has a width such that the at least one laser beam is applied to two or more trapped ions of the array simultaneously.

12. The method of claim 11, wherein the at least one laser beam has a width such that the at least one laser beam is applied to each trapped ion of the array simultaneously.

13. The method of claim 1, wherein the control operations include at least one of:
dissipative operations and coherent operations.

14. The method of claim 13, wherein the control operations are performed by applying the electric field to individual ions of the plurality of trapped ions to control translational and/or oscillation modes of the ions.

15. The method of claim 11, wherein the control operations include at least one of: tuning a Rabi frequency; transition frequency tuning; phase tuning; and entangling gate Rabi frequency tuning.

16. The method of claim 15, wherein the entangling gate Rabi frequency tuning is performed by one of: ion translation, mode frequency tuning, or mode orientation tuning.

17. The method of claim 13, wherein the coherent operations include quantum operations; and
wherein the quantum operations include at least one of single-qubit gate and multi-qubit gate.

18. The method of claim 12, wherein the dissipative operations include at least one of: state preparation, readout, and laser cooling.

19. The method of claim 1, wherein the trapped ions of the array of trapped ions encode quantum information.

20. A quantum device comprising:
an array of trapped ions comprising a plurality of trapped ions;
wherein the quantum device is configured to:
receive at least one laser beam from two or more laser light inputs;
apply at least one of the two or more lasers to the array of trapped ions; and
perform control operations using the quantum device by applying electric fields to the trapped ion array, wherein the electric field is generated by applying a voltage to a plurality of input ports of the quantum device.

21. The quantum device of claim 20, further comprising two or more laser light inputs.

1. A method for operating a quantum device, wherein the quantum device configured to receive at least one laser beam from two or more laser light inputs and comprising an array of trapped ions comprising a plurality of trapped ions, the method comprising:
applying the at least one laser beam to the array of trapped ions; and
performing control operations using the quantum device by applying electric fields to the trapped ion array, wherein the electric field is generated by applying a voltage to a plurality of input ports of the quantum device.

2. The method of claim 1, wherein the performing control operations comprises applying each electric field to a group of at least one trapped ion of the trapped ion array.

3. The method of claim 1, wherein applying the at least one laser beam comprises splitting each laser into a number of beams, wherein each beam is sent through at least one trapped ion of the array.

4. The method of claim 3, wherein the number of beams is:
equal to the number of trapped ions in the array; or
less than the number of trapped ions in the array; or
more than the number of trapped ions in the array.

5. The method of claim 1, wherein the plurality of trapped ions comprises a plurality of groups of trapped ion qubits;
wherein the array is configured such that the plurality of trapped ions are positioned to form spatially separated chain structures;
wherein each chain structure comprises one group of the plurality of groups of trapped ion qubits.

6. The method of claim 5, wherein applying the at least one laser beam comprises splitting each of the at least one laser beam into a number of beams sending the at least one laser beam through each trapped ion of a number of groups of the array sequentially.

7. The method of claim 6, wherein the number of beams is equal to the number of groups of trapped ions in the array.

8. The method of claim 5, wherein applying the at least one laser comprises splitting the at least one laser into a number of beams and sending the at least one laser through each trapped ion of a corresponding number of groups of the array sequentially.

9. The method of claim 5, wherein applying the at least one laser further comprises sending the at least one laser beam through each trapped ion of a group of the plurality of groups of trapped ions.

10. The method of claim 1, wherein applying the at least one laser beam comprises applying two laser beams at the same time.

11. The method of claim 5, wherein the at least one laser beam has a width such that the at least one laser beam is applied to two or more trapped ions of the array simultaneously.

12. The method of claim 11, wherein the at least one laser beam has a width such that the at least one laser beam is applied to each trapped ion of the array simultaneously.

13. The method of claim 1, wherein the control operations include at least one of:
dissipative operations and coherent operations.

14. The method of claim 13, wherein the control operations are performed by applying the electric field to individual ions of the plurality of trapped ions to control translational and/or oscillation modes of the ions.

15. The method of claim 11, wherein the control operations include at least one of: tuning a Rabi frequency; transition frequency tuning; phase tuning; and entangling gate Rabi frequency tuning.

16. The method of claim 15, wherein the entangling gate Rabi frequency tuning is performed by one of: ion translation, mode frequency tuning, or mode orientation tuning.

17. The method of claim 13, wherein the coherent operations include quantum operations; and
wherein the quantum operations include at least one of single-qubit gate and multi-qubit gate.

18. The method of claim 12, wherein the dissipative operations include at least one of: state preparation, readout, and laser cooling.

19. The method of claim 1, wherein the trapped ions of the array of trapped ions encode quantum information.

20. A quantum device comprising:
an array of trapped ions comprising a plurality of trapped ions;
wherein the quantum device is configured to:
receive at least one laser beam from two or more laser light inputs;
apply at least one of the two or more lasers to the array of trapped ions; and
perform control operations using the quantum device by applying electric fields to the trapped ion array, wherein the electric field is generated by applying a voltage to a plurality of input ports of the quantum device.

21. The quantum device of claim 20, further comprising two or more laser light inputs.
